(19) United States
(12) Patent Application Publication
(10) Pub. No.: US 2011/0103868 A1
(43) Pub. Date: May 5, 2011

(54) MEDIUM SUPPLYING UNIT AND IMAGE FORMING APPARATUS HAVING THE SAME

(75) Inventor: Je-Hwan YOU, Hwaseong-si (KR)

(73) Assignee: SAMSUNG ELECTRONICS CO., LTD., Suwon-si (KR)

(21) Appl. No.: 12/787,954

(22) Filed: May 26, 2010

(30) Foreign Application Priority Data
Nov. 2, 2009 (KR) 10-2009-0104862

(51) Int. Cl. B41J 15/00

(52) U.S. Cl. 400/613

(57) ABSTRACT

Disclosed is a printing media supply unit and an image forming apparatus employing the same for forming an image on the printing medium. A loading plate capable of supporting thereon a supply of the printing media is movably coupled to a detachable loading cassette so as to move in ascending and descending manner depending on the amount of printing media loaded on the loading plate. One of more interfering members are provided on the loading plate so as to move with the loading plate, and may be capable of being sensed by one or more sensing units. A control unit determines the amount of printing media based on the sensing results, which may be different from one sensing unit to another, or based on the combination of such sensing results.

### CROSS-REFERENCE TO RELATED APPLICATION

This application claims priority from Korean Patent Application No. 10-2009-0104862, filed on Nov. 2, 2009 in the Korean Intellectual Property Office, the disclosure of which is incorporated herein by reference in its entirety.

### TECHNICAL FIELD

The present disclosure relates generally to a medium supplying unit configured to load and supply a printing medium, as well as to an image forming apparatus having the same, and more particularly, to a medium supplying unit configured to calculate the loaded amount of printing media and an image forming apparatus having the same.

### BACKGROUND OF RELATED ART

An image forming apparatus, such as a printer, an electronic copier, a multifunction device, or the like, performs a printing process of forming an image based on image data provided from a host by using ink or developer, such as, e.g., toner. An image forming apparatus typically includes a medium supplying unit on which printing media are loaded, and from which the printing media are supplied for the printing process.

If the amount of printing media loaded in the medium supplying unit is insufficient, the printing process cannot be carried out completely. Accordingly, an image forming apparatus may typically provide some indication to the user of the amount of the available printing media using, for example, an indicator, the position of which varies to correspond to the amount of the printing media currently available, on an outer portion of the apparatus.

For example, some image forming apparatuses include an actuator that is pressed by a loading plate, on which the loaded printing media are supported, and an externally visible indicator that is interlocked with the actuator. As the rotational position of the loading plate varies depending on the weight of the loaded printing media, the position of the indicator is adjusted according to the resulting movement of the actuator. The user can identify the amount of the printing media currently loaded and thus available based on the current position of the indicator.

However, the implementation of the above discussed actuator/indicator arrangement may be complicated by the internal configuration in some image forming apparatus. The arrangement is also generally difficult to implement due to the required tight tolerance for the assembly of the loading plate, the actuator and the indicator. In addition, when the actuator is positioned in or near the loading area and/or the transport path along which the printing medium is supplied, as is done in some image forming apparatus, the actuator may even become a source of a printing medium jam.

A media supplying unit with an improved loading and supplying of the printing media is thus desirable.

### SUMMARY OF DISCLOSURE

A medium supplying unit, and an image forming apparatus including the medium supplying unit according to one or more aspects of the present disclosure, have a configuration in which the mounting and detaching position of the loading cassette with respect to the main body of an image forming apparatus and the position of the pickup roller are respectively disposed in front and rear of the main body, thereby allowing the amount of the loaded printing media to be calculated with a simpler configuration. Moreover, according to one or more aspects of the present disclosure, the medium supplying unit is configured to prevent jamming of the printing medium within the image forming apparatus.

According to an aspect of the present disclosure, an image forming apparatus may be provided to include a main body including an image forming unit configured to form an image on a printing medium, a loading cassette detachably mounted to the main body, a loading plate and a loaded amount calculating unit. The loading plate may be configured to support thereon a supply of printing media from which the printing medium is supplied to the image forming unit, and may be coupled to the loading cassette in such a manner capable of moving along a direction of varying elevation height thereof according to an amount of the printing media supported on the loading plate. The loaded amount calculating unit may be configured to determine the amount of the printing media supported on the loading plate, and may comprise a plurality of interfering members, a plurality of sensing units and a control unit. The plurality of interfering members may be coupled to an end portion of the loading plate. The plurality of sensing units may be arranged on the main body, and may each be configured to sense an interference by the respective corresponding one of the plurality of interfering members at a predetermined sensed position depending on the elevation height of the loading plate. The control unit may be configured to determine the amount of the printing media supported on the loading plate based on sensing results of the plurality of sensing units.

The plurality of interfering members may be arranged along a direction transverse to the transport direction along which the printing medium is supplied to the image forming unit from the loading plate.

The plurality of sensing units may be arranged so that the predetermined sensed position respectively of each of the plurality of sensing units has the substantially same height as that of the other ones of the plurality of sensing units.

The plurality of interfering members may comprise a first interfering member and a second interfering member disposed respectively on the right and left opposite sides of the end portion of the loading plate symmetrically about the printing media supported on the loading plate.

The first interfering member and the second interfering member may respectively comprise a first interference area and a second interference area sensed by the respective corresponding one of the plurality of sensing units. The first interference area and the second interference area may partially overlap each other over a range of heights.

The image forming apparatus may further comprise a display unit disposed on the main body, the display unit being configured to display the amount of the printing media determined by the control unit.

The image forming apparatus may further comprise communicating unit configured to communicate with an external host device. The control unit may be configured to provide to the host device the determined amount of the printing media through the communicating unit.

The loading cassette may be mounted and detached through the front portion of the main body. The image forming apparatus may further comprise a pickup roller disposed at the rear portion of the main body. The pickup roller may be configured to pick up the printing medium from the supply of printing media supported on the loading plate, and to convey the picked up printing media toward the image forming unit.

The plurality of sensing units may each comprise a light emitting element configured to generate light and a light receiving element configured to receive light from the light emitting element. The respective corresponding one of the plurality of interfering members may selectively block the path of light between the light emitting element and the light receiving element in dependence of the elevation height of the loading plate.

The plurality of interfering members may be formed integrally with the loading plate.

According to another aspect of the present disclosure, a medium supplying unit may be provided to include a loading cassette detachably receivable in a main body of an image forming apparatus, a loading plate configured to support thereon printing media, the loading plate being coupled to the loading cassette in such a manner to ascend or descend according to an amount of the printing media supported on the loading plate and a loaded amount calculating unit configured to determine the amount of the printing media supported on the loading plate. The loaded amount calculating unit may comprise a plurality of interfering members coupled to an end portion of the loading plate, a plurality of sensing units arranged on the main body, the plurality of sensing units each being configured to sense an interference by respective corresponding one of the plurality of interfering members at a predetermined sensed position depending on an elevation height of the loading plate and a control unit configured to determine the amount of the printing media supported on the loading plate based on sensing results of the plurality of sensing units.

According to yet another aspect of the present disclosure, an apparatus may be provided for supplying a printable medium usable in an image forming apparatus for forming an image thereon. The apparatus may comprise a loading cassette detachably mountable to a main body of the image forming apparatus, a loading plate and first and second interfering members. The loading plate may be configured to support thereon a supply of printable media from which the printable medium is supplied to an image forming unit within the main body of the image forming apparatus. A first end portion of the loading plate may be movably coupled to the loading cassette in such a manner that a second end portion away from and opposite the first end portion is capable of moving along a direction of varying elevation height thereof according to an amount of the printing media being supported on the loading plate. The first and second interfering members may each be coupled to the second end portion of the loading plate in such a manner movable together with the loading plate. The first interfering member may have a first interfering surface extending away from the loading plate. The second interfering member may have a second interfering surface extending away from the loading plate. The first and second interfering surfaces being of respective shapes different from one another.

Each of the first and second interfering surfaces may extend substantially perpendicular to the loading plate.

### BRIEF DESCRIPTION OF THE DRAWINGS

Various features and advantages of the disclosure will become more apparent by the following detailed description of several embodiments thereof with reference to the attached drawings, of which:

FIG. 1 is a side sectional view of an image forming apparatus according to an embodiment;

FIG. 2 is a perspective view illustrating a medium supplying unit and a loaded amount calculating unit in accordance with an embodiment;

FIG. 3 is a functional block diagram illustrative of the operation of a loaded amount calculating unit in accordance with an embodiment;

FIG. 4 is a plan view illustrating a medium supplying unit and a loaded amount calculating unit in accordance with an embodiment;

FIG. 5 is a perspective view of the relevant portions of a first interfering member and a first sensing unit of an image forming apparatus in accordance with an embodiment;

FIG. 6 is a side view illustrative of the relevant portions of a first interfering member and a second interfering member of an image forming apparatus in accordance with an embodiment;

FIG. 7 illustrates an interference of a first interfering member and a second interfering member with respect to a sensing position in accordance with an embodiment; and

FIG. 8 illustrates an interference of a first interfering member and a second interfering member according to another embodiment.

### DETAILED DESCRIPTION OF SEVERAL EMBODIMENTS

Reference will now be made in detail to embodiments of the present invention, examples of which are illustrated in the accompanying drawings, wherein like reference numerals refer to like elements. While the embodiments are described with detailed construction and elements to assist in a comprehensive understanding of the various applications and advantages of the embodiments, it should be apparent however that the embodiments can be carried out without those specifically detailed particulars. Also, well-known functions or constructions will not be described in detail so as to avoid obscuring the description with unnecessary detail. It should be also noted that in the drawings, the dimensions of the features are not intended to be to true scale and may be exaggerated for the sake of allowing greater understanding.

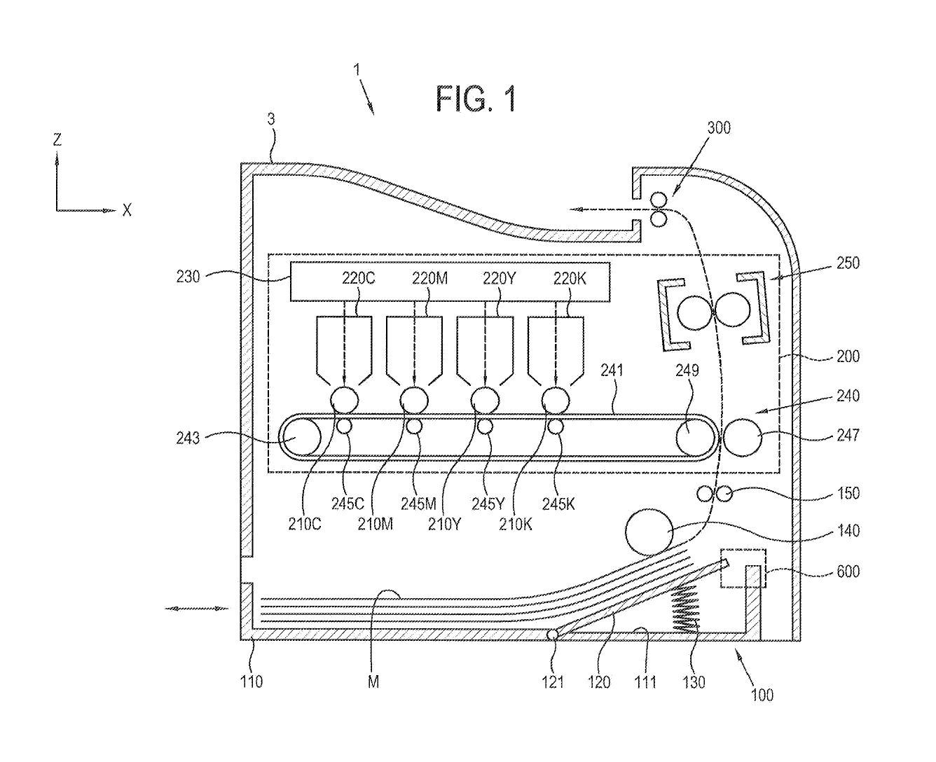

FIG. 1 is a side sectional view of an image forming apparatus according to an embodiment, in which the indicated directions X, Y (i.e., normal to the figure sheet) and Z respectively represent the length, width and the height. FIG. 1 illustrates a cross-section along a X-Z plane of an image forming apparatus 1, where the front of the image forming apparatus 1 is on the left side of drawing, and whereas the rear thereof is on the right side of the drawing.

As shown in FIG. 1, various component elements may be accommodated inside a main body 3 of the image forming apparatus 1. For example, the image forming apparatus 1 may include a medium supplying unit 100 configured to be loaded with, and to supply, printing media M, an image forming unit 200 configured to form an image on a printing medium M received from the medium supplying unit 100 and a medium discharging unit 300 configured to discharge a printing medium M formed with the image thereon.

The medium supplying unit 100 may include, according to an embodiment, a loading cassette 110 detachably received in the main body 3, a loading plate 120 moveably coupled to the loading cassette 110 and configured to hold printing medium M thereon, an elastic member 130 upwardly pressing and supporting the loading plate 120, a pickup roller 140 configured to pick up and to supply a printing medium M loaded on the loading plate 120 and a registration roller 150 configured to convey the printing medium M picked up by the pickup roller 140 to the image forming unit 200.

The loading cassette 110 is, according to an embodiment, configured to form an accommodating space capable of holding the printing media therein. An upper side portion of the loading cassette 110 may be opened so that a user can load the printing medium M in the accommodating space. Moreover, the loading cassette 110 may be configured as a detachably mounted component with respect to the main body 3.

The loading plate 120 may be embodied as a rectangular plate and may be disposed within the accommodating space of the loading cassette 110 in which the printing medium M is to be accommodated. The loading plate 120 may be disposed on an upper cassette surface 111 of the loading cassette 110, and may be rotatably coupled at an end portion thereof to the loading cassette 110 by a hinge unit 121, thus allowing the loading plate 120 to rotate about the hinge unit 121. The other free end portion of the loading plate 120 (i.e., the end portion away from the hinge unit 121 and opposite the coupled end) is capable of ascending upwardly toward the pickup roller 140 and of descending downwardly toward the upper cassette surface 111.

According to an embodiment of the present disclosure, the elastic member 130 is positioned between the upper cassette surface 111 and the lower surface of the loading plate 120. The elastic member 130 may be configured to elastically bias, that is to press or lift, the loading plate 120 toward the pickup roller 140 and away from the upper cassette plate 111. With such configuration, if the printing media M is loaded on the loading plate 120, the loading plate 120 may ascend to a position to allow the topmost printing medium M loaded on the loading plate 120 to be picked up by the pickup roller 140. As the loaded amount of the printing media M decreases as they are used up during the printing processes, the loading plate 120 is configured to gradually ascend so as to continue to enable the topmost printing medium M to be picked up.

The pickup roller 140 is accordingly configured to pick up the topmost printing medium M of the printing medium M loaded on the loading plate 120, and to convey the picked up printing medium M toward the registration roller 150 during a printing process.

The registration roller 150 is configured to align the leading edge of the printing medium M received from the pickup roller 140 and to feed the printing medium M further along the printing medium transport path toward the image forming unit 200 at an appropriate timing.

According to an embodiment of the present disclosure, the image forming unit 200 may include image carrying bodies 210C, 210M, 210Y and 210K on which respective electrostatic latent images are to be formed, developing cartridges 220C, 220M, 220Y and 220K configured to form a visible image by developing the electrostatic latent images of the respective image carrying body 210C, 210M, 210Y and 210K with developer, an exposing unit 230 configured to form the electrostatic latent image corresponding to the desired image on the image carrying bodies 210C, 210M, 210Y and 210K by light exposure, a transferring unit 240 configured to transfer the visible image from the image carrying bodies 210C, 210M, 210Y and 210K to the printing medium M, and a fusing unit 250 configured to fix the transferred image onto the printing medium M.

With the outer surface thereof uniformly charged, the image carrying bodies 210C, 210M, 210Y and 210K are exposed to light received from the exposing unit 230 so that electrostatic latent images are formed on the outer surfaces thereof. The image forming apparatus 1, according to an embodiment, may use cyan, magenta, yellow and black colored developers respectively corresponding to the image carrying bodies 210C, 210M, 210Y and 210K. The developing cartridges 220C, 220M, 220Y and 220K accordingly correspond respectively to the carrying body 210C, 210M, 210Y and 210K, and store therein the respective one of the four individual color developers.

The exposing unit 230 may be configured to divide the image data for the desired final image to be formed into subsets of data for each color or to receive the image data already divided into such subsets of data, and may be further configured to scan a light beam across a charged surface of each of the image carrying body 210C, 210M, 210Y and 210K in a pattern corresponding to the respective subset of image data. The exposed portions of the surface of an image carrying body undergoes a potential change, thereby forming an electrostatic latent image corresponding to sub image of each individual color as a pattern of potential differences on each of the image carrying bodies 210C, 210M, 210Y and 210K. The electrostatic latent image on each of the image carrying bodies are then developed with the corresponding colored developer by developing cartridges 220C, 220M, 220Y and 220K into visible images of respective individual colors on the image carrying bodies.

The transferring unit 240 is configured to transfer each of the visible images from the image carrying body 210C, 210M, 210Y and 210K onto a printing medium M, and in this example, using a so-called an intermediate transfer method. That is, the transferring unit 240 according to an embodiment may include an intermediate transferring belt 241 configured to rotate in contact with each image carrying body 210C, 210M, 210Y and 210K, a belt driving roller 243 configured to rotate the intermediate transferring belt 241, middle transferring rollers 245C, 245M, 245Y and 245K configured to oppose respectively the image carrying bodies 210C, 210M, 210Y and 210K so as to assist in the transfer of the visible images from the image carrying bodies onto the middle transferring belt 241, a final transferring roller 247 configured to transfer the visible image from the intermediate transferring belt 241 onto a printing medium M and a transferring backup roller 249 configured to back up and oppose the final transferring roller 247 with the intermediate transferring belt 241 interposed therebetween so as to assist in the transfer of the visible images onto the printing medium M.

The intermediate transferring belt 241, when used, serves as an intermediary transfer medium between the image carrying bodies and the printing medium M, and is made to rotate at a predetermined speed in contact with the image carrying bodies such that the individual color visible images from the image carrying bodies are transferred onto the intermediate transferring belt 241 overlapping one another so that a full color image as a superimposed combination of the individual color images is formed on the intermediate transferring belt 241. Such full color image can then be transferred onto the printing medium M from the intermediate transferring belt 241 as the printing medium passes the final transferring roller 247 at the appropriate timing as fed by the registration rollers 150. The printing medium bearing the transferred full color image then travels further to the fusing unit 250, which applies heat and/or pressure to cause the image to be fixed or melted on the printing medium M. The printing medium M bearing the fixed image is discharged out of the image forming apparatus 1 by the medium discharging unit 300, thus completing an image forming operation.

According to an embodiment, as illustrated in FIG. 1, the loading cassette 110 may be mounted and detached through the front portion of the main body 3 of the image forming apparatus 1, for example, through an opening provided on the front side (i.e., on the—X direction side) of the main body 3 whereas the free end portion of the loading plate 120 that is configured to be free to ascend and descend is positioned toward the rear side (i.e., on the X direction side) of the main body 3.

The image forming apparatus 1 according to an embodiment of the present disclosure may further include a loaded amount calculating unit 600 disposed toward the rear portion of the main body 3 that is configured to calculate the amount of the printing medium M loaded on the loading plate 120, for example, based on the elevation position of the loading plate 120.

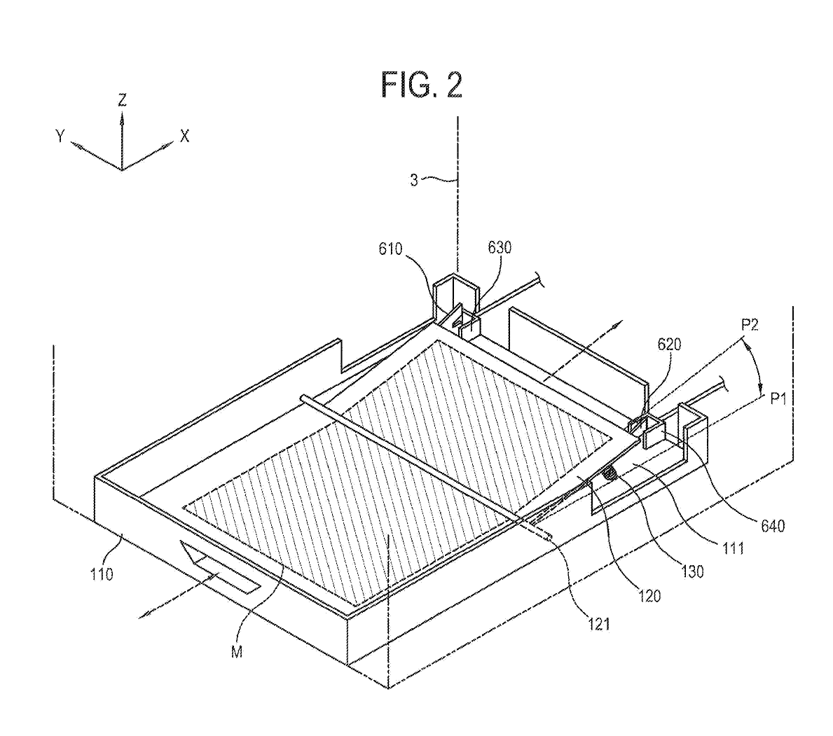

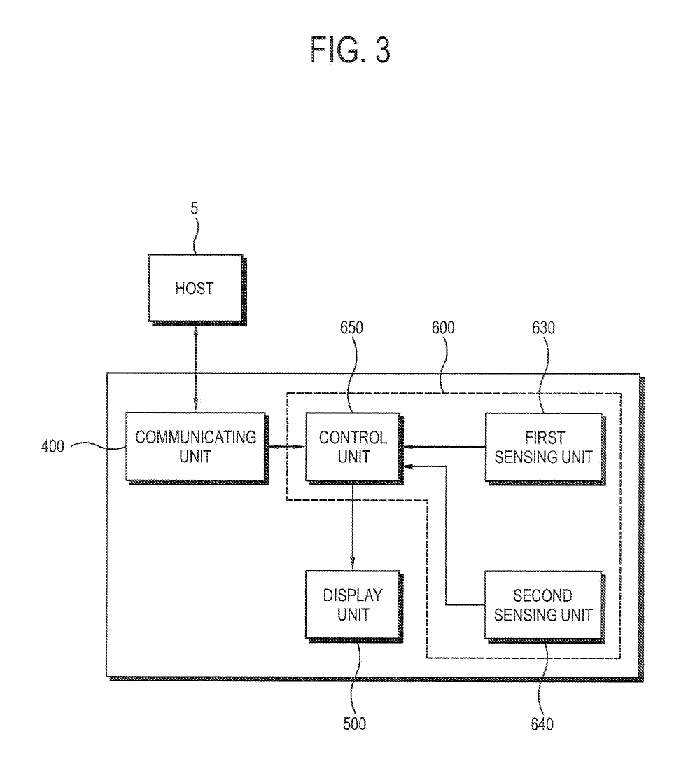

FIG. 2 is a perspective view illustrating portions of the medium supplying unit 100 and the loaded amount calculating unit 600 whereas FIG. 3 provides a functional block diagram illustrative of the operation of the loaded amount calculating unit 600.

As shown in FIG. 2, the loading cassette 110 may be received in the main body 3 of the image forming apparatus 1 with the printing media M loaded on the loading plate 120. The loading plate 120 may, by an elastic force of the elastic member 130, rotate to a position in which a printing medium M is capable of being picked up, which position may vary depending on the amount of the printing media M loaded on the loading plate 120.

For example, if the maximum amount of the printing medium M allowed such as, for example 200 sheets of paper, is loaded on the loading plate 120, the loading plate 120 may be positioned at the position P1 most vicinal or proximate to the upper cassette surface 111.

As the amount of the printing medium M decreases as the printing operations are performed, the loading plate 120 rotates upwardly so that the topmost printing medium M can be picked up. If all of the printing media is used up so that there is no more printing medium M on the loading plate 120, the loading plate 120 may have rotated to reach the position P2, which may, for example, be the maximum ascending position allowed by the elastic member 130. That is, the loading plate 120 may rotate between the positions P1 and P2 depending on the amount of the printing medium M loaded on the loading plate 120.

According to an embodiment, the loaded amount calculating unit 600 may include one or more interfering members, for example, interfering members 610 and 620, coupled to the loading plate 120, one or more sensing units, for example, sensing units 630 and 640, supported on the main body 3 and a control unit 650. The sending unit(s) may be configured to sense the interference by the corresponding one of the interfering member(s) being positioned according to the elevation height of the loading plate 120. The control unit 650 may be configured to calculate the amount of the printing medium M loaded on the loading plate 120 based on the result of the sensing operations by the sensing unit(s).

As shown in FIG. 2, according to an embodiment, the interfering members 610 and 620 may extend along a direction that is transverse to the direction along which the printing medium M is fed to the image forming unit 200, and may be arranged at the free end portion of the loading plate 120 opposite the end that is rotatably coupled to the hinge unit 121. The interfering members 610 and 620 may be formed integrally with the loading plate 120 or may be otherwise coupled to the loading plate 120 in such a manner the interfering members 610 and 620 moves together in an interlocked manner with the upward and downward movements of the loading plate 120.

According to an embodiment, the interfering members may include a first interfering member 610 and a second interfering member 620 positioned on opposite sides of the free end portion of the loading plated 120 symmetrically about the printing medium M loaded on the loading plate 120.

According to an embodiment, the sensing unit(s) may include a first sensing unit 630 and a second sensing unit 640 respectively configured to sense the interference by the first interfering member 610 and by the second interfering member 620, and may transmit the result of the sensing to the control unit 650.

The sensing units 630 and 640 may be positioned on the respective elevating movement path of the interfering members 610 and 620. The sensing units 630 and 640 may be supported on the main body 3, and may be communicatively connected to, and thus capable of transmitting a sensing signal, to the control unit 650.

According to an embodiment of the present disclosure, the sensing units 630 and 640 may be configured to sense whether an interference by the interfering members 610 and 620 is observed at one or more predetermined positions within the elevating movement path of the interfering members 610 and 620, and to transmit the sensing result to the control unit 650. The predetermined positions may be designated to be various positions between the maximum ascending position and the maximum descending position of the interfering members 610 and 620, and may vary depending on the various design considerations and requirements of the particular implementation.

According to an embodiment, the sensing units 630 and 640 may be implemented as, for example, an optical or light sensor. That is, the sensing units 630 and 640 may include a light emitting element (not shown) for generating and emitting a light and a light receiving element (not shown) for receiving the light from the light emitting element. If the light path between the light emitting element and the light receiving element is blocked by the interfering members 610 and 620, the light receiving element may transmit to the control unit 650 a signal indicating that the light path is blocked.

The control unit 650 may be configured to calculate the loaded amount of the printing medium M based on each sensing result transmitted from the first sensing unit 630 and the second sensing unit 640. According to an embodiment, the control unit 650 may combine the respective sensing results of the first sensing unit 630 and the second sensing unit 640, and may calculate a range of the amount of the printing medium M loaded on the loading plate 120 based on the combined sensed results.

The control unit 650 may be configured to display the calculated loaded amount in a display unit 500 or to transmit the amount to an external host 5 through a communicating unit 400. The display unit 500 may be a liquid crystal display, for example, disposed on the outer portion of the main body 3 so as to display, for example, operational status of the image forming apparatus 1. The communicating unit 400 may be connected to the host 5, for example, through a network, to allow the host 5 to display, for example, on a display monitor (not shown), the amount of available printing media M based on the information received from the communicating unit 400.

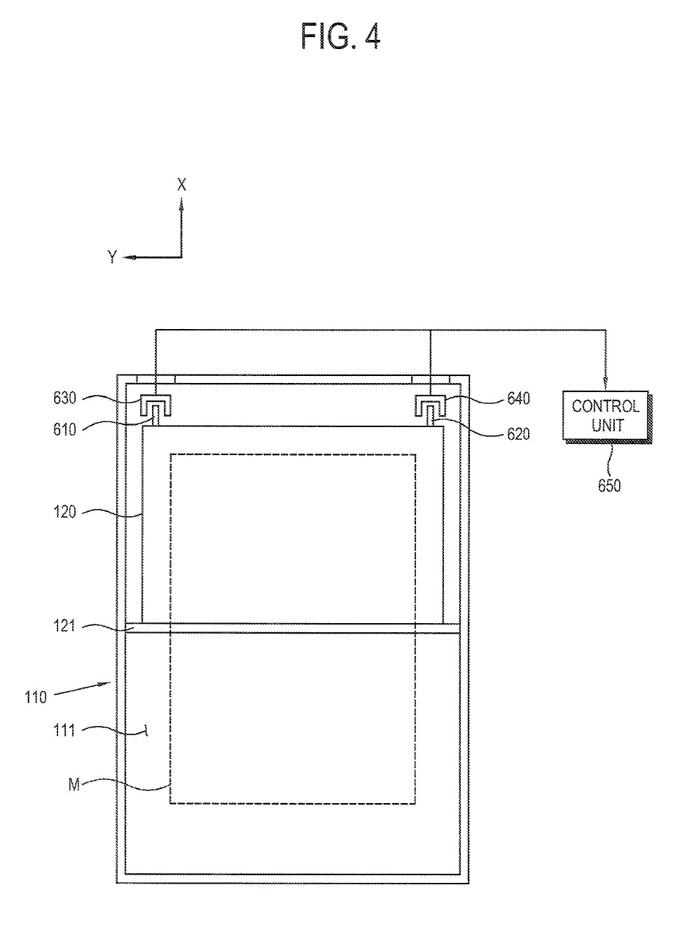

Shown in FIG. 4 is the medium supplying unit 100 and the loaded amount calculating unit 600 according to an embodiment. The lower portion of the printing medium M may be loaded on the upper cassette surface 111 while the upper portion of the printing medium M may be loaded on the loading plate 120. During a printing process, the printing medium M is picked up by the pickup roller 140 to be transported in the direction X.

According to an embodiment, the first interfering member 610 and the second interfering member 620 may be arranged on opposite sides symmetrically about the loaded printing medium M. Since the first interfering member 610 and the second interfering member 620 are disposed at positions away from the loading and the transporting areas of the printing medium M, the printing medium M is less likely to jammed, that is to be stuck, in the loading area or in the transporting area, as a result also lessening the likelihood of such printing medium jam affecting the calculation of the amount of loaded printing media M.

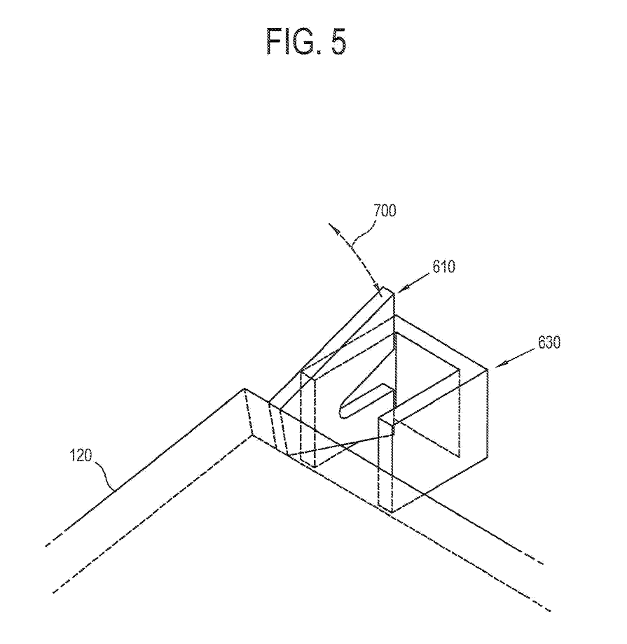

FIG. 5 is a perspective view illustrating the first interfering member 610 and the first sensing unit 630 according to an embodiment. As shown in FIG. 5, the first interfering member 610 is coupled to an end portion of the loading plate 120 so as to move upwardly and downwardly, together with the loading plate 120 as the loading plate 120 pivots, forming an elevating path 700. The first sensing unit 630 may sense the interference by the first interfering member 610 at predetermined position(s) along the elevating path 700.

If the first interfering member 610 does not interfere at the predetermined position(s), the first sensing unit 630 may not output a sensing signal to the control unit 650. On the other hand, if the first interfering member 610 interferes at the predetermined position(s), the first sensing unit 630 may output a sensing signal to the control unit 650.

The second interfering member 620 and the second sensing unit 640 may have substantially the same configurations as the first interfering member 610 and the first sensing unit 630, respectively.

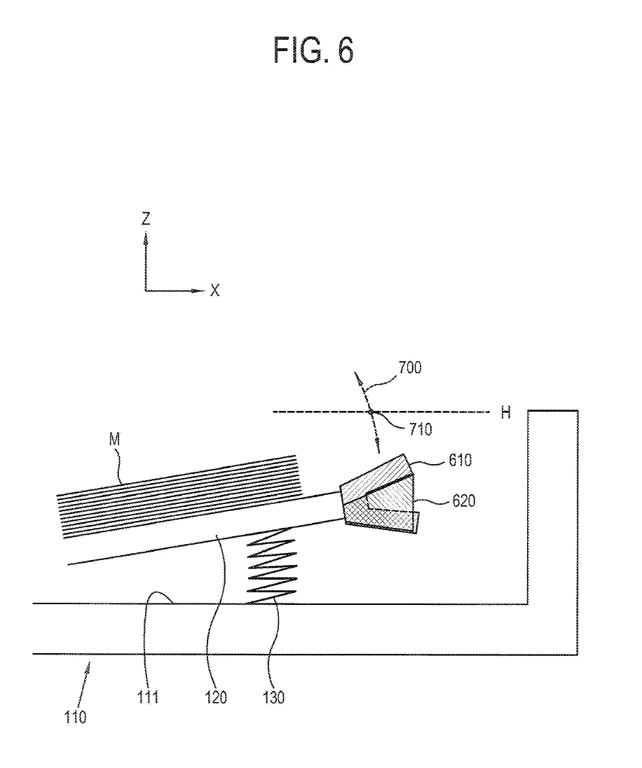

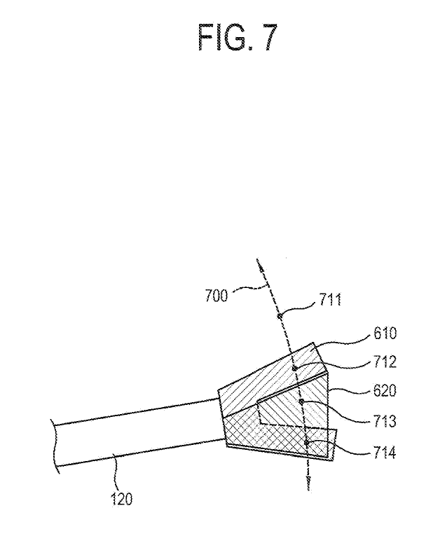

With reference to FIGS. 6 and 7, examples of the configuration and the calculation of the loaded amount of the printing medium M by the loaded amount calculating unit 600 according to an embodiment will be described.

FIG. 6 is a side view illustrating the first interfering member 610 and the second interfering member 620. The movement of the first interfering member 610 may be interlocked with the movement of the loading plate 120 to form an elevating path 700. By way of an example, when the first sensing unit 630 reaches the height H along the elevating path 700, and is thus sensed by the first sensing unit 630 at the sensing position 710, which may be one of the predetermined sensing position(s), the first sensing unit 630 may output a sensing signal.

While, in FIG. 6, the respective elevating paths 700 of the first interfering member 610 and the second interfering member 620 are illustrated to appear overlapping one another, the respective paths are not on the same plane. According to an embodiment, the respective sensing positions of the first sensing unit 630 and the second sensing unit 640 may be substantially at the same height H. That is, for example, as they are illustrated in FIG. 6 to overlap each other, the sensing positions 710 for the second sensing unit 640 may be at substantially the same height as the sensing position 710 of the first sensing unit 630.

Each of the first interfering member 610 and the second interfering member 620 has a respective interference area that is sensed respectively by the first sensing unit 630 and the second sensing unit 640. When viewed at the same height, portions of the respective interference areas of the first interfering member 610 and the second interfering member 620 may overlap one another.

For example, in FIG. 6, the second interfering member 620 is illustrated as being positioned in front of the first interfering member 610. In FIG. 6, an area indicated by the right inclined hatched lines represents the interference area of the first interfering member 610 whereas the area indicated by the left inclined hatched lines represent the interference area of the second interfering member 620. The area indicated by the cross-hatched lines represents the area in which the respective interference areas of the first interfering member 610 and the second interfering member 620 overlap each other.

The loading plate 120 is configured to ascend or descend depending on the loaded amount of the printing media M, thereby enabling the first interfering member 610 and the second interfering member 620 coupled to an end portion thereof to ascend and descend along the respective elevating path 700. The amount of printing media M loaded on the loading plate 120 can be calculated based on the combined sensed status of the first interfering member 610 and the second interfering member 620, for example, at the sensing position 710.

FIG. 7 is illustrative of various interfering states of the first interfering member 610 and the second interfering member 620 at the sensing position 710. In FIG. 7, a first sensing position 711, a second sensing position 712, a third sensing position 713 and a fourth sensing position 714 are illustrated along the elevating path 700. These sensing positions 711, 712, 713 and 714 each represent the sensing position 710 shown in FIG. 6 illustrated in a single drawing, in relation to various elevating positions of the first interfering member 610 and the second interfering member 620. For example, when the first interfering member 610 and the second interfering member 620 are positioned at a position lower than the sensing position 710 in FIG. 6, the sensing position 710 of FIG. 6 may be represented, in relation to the position of the interfering members 610 and 620, by the first sensing position 711 of FIG. 7.

Considering the case in which the relative position of the sensing position 710 corresponds to the first sensing position 711, the amount of the printing media M loaded on the loading plate 120 may be the maximum amount so as to cause the loading plate 120 to descend below the sensing position 710. As the first interfering member 610 and the second interfering member 620 are both below and away from the sensing position 710, and as the interfering members thus do not interfere with the respective sensing units, the first sensing unit 630 and the second sensing unit 640 do not output a sensing signal to the control unit 650. For example, if the maximum capacity for the loading plate 120 is 200 sheets the fact that neither the first and second sensing units has output a sensing signal can be used to make the determination that the amount of the printing medium M loaded on the loading plate 120 is 150 sheets to 200 sheets.

When the relative position of the sensing position 710 corresponds to the second sensing position 712, that is. for example, if the amount of the printing media M loaded on the loading plate 120 is 100 sheets to 150 sheets, the loading plate 120 ascends from the above described position at which the loading plate supporting 150 to 200 sheets. At such position of the loading plate, while the first interfering member 610 interferes with the sensing unit 630 at the sensing position 710 (712), the second interfering member 620 does not interfere with the sensing unit 640 at the sensing position 710 (712). Accordingly, the first sensing unit 630 outputs a sensing signal while the second sensing unit 640 does not output a sensing signal.

When the sensing position 710 corresponds to the third sensing position 713 of FIG. 7, that is, for example, if the amount of the printing media M loaded in the loading plate 120 is 50 sheets to 100 sheets, the first interfering member 610 does not interfere with the sensing unit 630 at the sensing position 710 while the second interfering member 620 interferes with the sensing unit 640 at the sensing position 710. Accordingly, the first sensing unit 630 does not output a sensing signal whereas the second sensing unit 640 outputs a sensing signal.

When the loading plate has further ascended so that the relative position of the sensing position 710 corresponds to the fourth sensing position 714, for example, if the amount of the printing media M loaded on the loading plate 120 is less than 50 sheets, each of the first interfering member 610 and the second interfering member 620 interferes with the respective sensing units 630 and 640 at the sensing position 710, thereby causing each of the first sensing unit 630 and the second sensing unit 640 to output a sensing signal.

According to an embodiment, the control unit 650 may determine the amount or a range of amounts of the printing media M loaded on the loading plate 120 based on the combination of the sensing results output from the first sensing unit 630 and the second sensing unit 640. For example, the control unit 650 may be provided with data or information relating to the corresponding relationship between the amount or a range of printing media M and the sensing results, and may compare the sensing results of the first sensing unit 630 and the second sensing unit 640 with such data or information in order to determine the amount of the printing media M presently loaded.

For example, if neither of the first sensing unit 630 nor the second sensing unit 640 outputs a sensing signal, the control unit 650 may determine the loaded amount of the printing media M to be between 150 sheets to 200 sheets. If the first sensing unit 630 outputs a sensing signal while the second sensing unit 640 does not output a sensing signal, the control unit 650 may determine the loaded amount of the printing media M to be in the range of 100 sheets to 150 sheets. If the first sensing unit 630 does not output a sensing signal and the second sensing unit 640 outputs a sensing signal, the control unit 650 may determine the loaded amount of the printing media M to be between 50 sheets to 100 sheets. If the first sensing unit 630 and the second sensing unit 640 both output sensing signals, the control unit 650 may determine that the loaded amount of the printing media M is less than 50 sheets.

The control unit 650 may, according to an embodiment, display the loaded amount of the printing media M determined as described above in the display unit 500 to inform a user. The control unit 650 may in addition transmit the determined amount of the printing media M to the host 5 through the communicating unit 400 so as to allow host 5 to display or otherwise make use of information for the available amount of the printing media M.

Thus, according to an aspect of the present disclosure, the loaded amount calculating unit 600 is employed to calculate and/or display the amount of the available printing media M with a simpler configuration. The specific numbers for the amount of the printing media in the above examples are merely non-limiting illustrative examples.

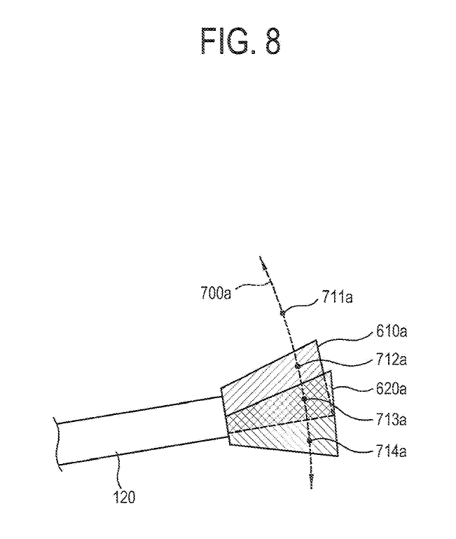

FIG. 8 illustrates the operation of the first interfering member 610a and the second interfering member 620a according to another embodiment. As shown in FIG. 8, the first interfering member 610a has an interference area indicated by the right inclined hatched lines, whereas the second interfering member 620a has an interference area indicated by the left inclined hatched lines. The first interfering member 610a and the second interfering member 620a have respective interference areas that overlap one another over a height ranges, which overlapping areas are indicated in FIG. 8 with the cross hatching.

As the amount of the loaded printing media M decreases, the relative position of the sensing position 710 relative to the first interfering member 610a and the second interfering member 620a varies between a first sensing position 711a, a second sensing position 712a, a third sensing position 713a and a fourth sensing position 714a.

Since the shapes of the first interfering member 610a and the second interfering member 620a according to the embodiment illustrated in FIG. 8 are different from the embodiment previously illustrated in FIG. 7, the determination of the amount of the loaded printing media M corresponding to the various combinations of the sensing results output from the first sensing unit 630 and the second sensing unit 640 may also be different from that previously described in reference to the embodiment of FIG. 7.

For example, if the relative positioning of the sensing position 710 corresponds to the third sensing position 713a, each of the first sensing unit 630 and the second sensing unit 640 outputs a sensing signal, in which case the control unit 650 may determine that the amount of the printing media M to be in the range of 50 sheets to 100 sheets, using the same 200 maximum capacity example. If, on the other hand, the sensing position 710 corresponds to the fourth sensing position 714a, the first sensing unit 630 does not output a sensing signal while the second sensing unit 640 outputs a sensing signal, in which case the control unit 650 may determine the amount of the loaded printing media M to be less than 50 sheets.

While a detailed structure of the control unit 650 is not depicted in FIG. 3, as would be readily understood by those skilled in the art, the control unit 650 may be, e.g., a microprocessor, a microcontroller or the like, that includes a CPU to execute one or more computer instructions to implement the various control operations herein described and/or control operations relating to the image forming apparatus or to one or more components of the image forming apparatus, such as, for example, one or more of the printing medium supply unit 100, the exposure unit 230, the image forming unit 200, the transfer unit 240 and the discharging unit 300, and to that end may further include a memory device, e.g., a Random Access Memory (RAM), Read-Only-Memory (ROM), a flesh memory, or the like, to store the one or more computer instructions.

As can be appreciated from the above examples, the specific shapes and the overlapping areas of the first interfering member and the second interfering member, as well as the determination by the control unit 650 based on the sensing results thereof may be variously changed.

According to one or more aspects of the present disclosure, by providing a loaded amount calculating unit of one or more of several embodiments herein described for the determination of the amount of available printing media, simpler assembly, increased productivity and/or greater design/manufacturing tolerance can be realized, thereby contributing to the improvement of an image forming apparatus.

According to one or more aspects of the present disclosure, by positioning and configuring the interfering member(s) and the sensing unit(s) away from the loading and/or the transporting areas of the printing media, the occurrences of printing medium jam, particularly, by the loaded amount calculating unit, or adverse impact of such printing medium jam on the determination of the amount of the loaded printing media, can be reduced.

Moreover, a loaded amount calculating unit according to one or more embodiments hereof may be employed in an image forming apparatus whose configuration makes the implementation of the conventional actuator and interlocked indicator mechanism difficult.

Further, according to one or more aspects of the present disclosure, with a relatively simpler structure or configuration, it may be possible to make the determination of the amount of available printing media in various steps of ranges. For example, as illustrated by several embodiments hereof, by providing an overlap of the respective portions of areas to be sensed of two interfering members, the amount of printing media can be calculated in four range steps.

In addition, the integration of an interfering member to a loading plate may be accomplished by a relatively simple process that may not require a separate assembling process.

Also, by providing a display of the amount of the available printing media on a display unit of an image forming apparatus, or by outputting the same to an external host, a user can easily identify or obtain the printing media amount at a desired location.

While the disclosure has been particularly shown and described with reference to several embodiments thereof with particular details, it will be apparent to one of ordinary skill in the art that various changes may be made to these embodiments without departing from the principles and spirit of the invention, the scope of which is defined in the following claims and their equivalents.

What is claimed is:

1. An image forming apparatus, comprising:
a main body including an image forming unit configured to form an image on a printing medium;
a loading cassette detachably mounted to the main body;
a loading plate configured to support thereon a supply of printing media from which the printing medium is supplied to the image forming unit, the loading plate being coupled to the loading cassette in such a manner capable of moving along a direction of varying elevation height thereof according to an amount of the printing media supported on the loading plate; and
a loaded amount calculating unit configured to determine the amount of the printing media supported on the loading plate, the loaded amount calculating unit comprising:
a plurality of interfering members coupled to an end portion of the loading plate;
a plurality of sensing units arranged on the main body, the plurality of sensing units each being configured to sense an interference by respective corresponding one of the plurality of interfering members at a predetermined sensed position depending on the elevation height of the loading plate; and
a control unit configured to determine the amount of the printing media supported on the loading plate based on sensing results of the plurality of sensing units.

2. The image forming apparatus according to claim 1, wherein the plurality of interfering members are arranged along a direction transverse to a transport direction along which the printing medium is supplied to the image forming unit from the loading plate.

3. The image forming apparatus according to claim 1, wherein the plurality of sensing units are disposed so that the predetermined sensed position respectively of each of the plurality of sensing units has the substantially same height as that of the other ones of the plurality of sensing units.

4. The image forming apparatus according to claim 3, wherein the plurality of interfering members comprise a first interfering member and a second interfering member disposed respectively on the right and left opposite sides of the end portion of the loading plate symmetrically about the printing media supported on the loading plate.

5. The image forming apparatus according to claim 4, wherein the first interfering member and the second interfering member respectively comprise a first interference area and a second interference area sensed by respective corresponding one of the plurality of sensing units, and
wherein the first interference area and the second interference area partially overlap each other over a range of heights.

6. The image forming apparatus according to claim 1, further comprising a display unit disposed on the main body, the display unit being configured to display the amount of the printing media determined by the control unit.

7. The image forming apparatus according to claim 1, further comprising a communicating unit configured to communicate with an external host device,
wherein the control unit is configured to provide to the host device the determined amount of the printing media through the communicating unit.

8. The image forming apparatus according to claim 1, wherein the loading cassette is mounted and detached through a front portion of the main body, and
wherein the image forming apparatus further comprises a pickup roller disposed at a rear portion of the main body, the pickup roller being configured to pick up the printing medium from the supply of printing media supported on the loading plate, and to convey the picked up printing media toward the image forming unit.

9. The image forming apparatus according to claim 1, wherein the plurality of sensing units each comprises:
a light emitting element configured to generate light, and
a light receiving element configured to receive light from the light emitting element, the respective corresponding one of the plurality of interfering members selectively blocking a path of light between the light emitting element and the light receiving element in dependence of the elevation height of the loading plate.

10. The image forming apparatus according to claim 1, wherein the plurality of interfering members are formed integrally with the loading plate.

11. A medium supplying unit having a loading cassette detachably receivable in a main body of an image forming apparatus, comprising:
a loading plate configured to support thereon printing media, the loading plate being coupled to the loading cassette in such a manner to ascend or descend according to an amount of the printing media supported on the loading plate; and
a loaded amount calculating unit configured to determine the amount of the printing media supported on the loading plate, the loaded amount calculating unit comprising:
a plurality of interfering members coupled to an end portion of the loading plate;
a plurality of sensing units arranged on the main body, the plurality of sensing units each being configured to sense an interference by respective corresponding one of the plurality of interfering members at a predetermined sensed position depending on an elevation height of the loading plate; and
a control unit configured to determine the amount of the printing media supported on the loading plate based on sensing results of the plurality of sensing units.

12. The medium supplying unit according to claim 11, wherein the plurality of sensing units are disposed so that the predetermined sensed position respectively of each of the plurality of sensing units has the substantially same height as that of the other ones of the plurality of sensing units.

13. The medium supplying unit according to claim 11, wherein the plurality of sensing units are disposed so that a position sensed by each of the sensing units has the substantially same height.

14. The medium supplying unit according to claim 13, wherein the plurality of interfering members comprise a first interfering member and a second interfering member disposed respectively to the right and left opposite sides and symmetrically about the printing media supported on the loading plate.

15. The medium supplying unit according to claim 14, wherein the first interfering member and the second interfering member respectively comprise a first interference area and a second interference area sensed by each of the sensing units, and
wherein the first interference area and the second interference area partially overlap each other over a range of heights.

16. The medium supplying unit according to claim 11, wherein the control unit is configured to cause the determined amount of the printing media loaded on the loading plate to be displayed at a display unit disposed on the main body, or to cause an information regarding the determined amount of the printing media loaded on the loading plate through a communicating unit to an external host device.

17. The medium supplying unit according to claim 11, wherein the sensing units comprise:
a light emitting element configured to generate light, and
a light receiving element configured to receive light from the light emitting element, the respective corresponding one of the plurality of interfering members selectively blocking a path of light between the light emitting element and the light receiving element in dependence of the elevation height of the loading plate.

18. The medium supplying unit according to claim 11, wherein the plurality of interfering members are formed integrally with the loading plate.
